(19) United States
(12) Patent Application Publication
(10) Pub. No.: US 2018/0218127 A1
(43) Pub. Date: Aug. 2, 2018

(54) Generating a Knowledge Graph for Determining Patient Symptoms and Medical Recommendations Based on Medical Information

(71) Applicant: Pager, Inc., New York, NY (US)

(72) Inventors: Oscar Salazar, New York, NY (US); Sameer Joseph Khanna, New York, NY (US); Sebastian Perez Saaibi, New York, NY (US)

(21) Appl. No.: 15/421,223

(22) Filed: Jan. 31, 2017

(51) Int. Cl. G06F 19/00

(52) U.S. Cl. CPC G06F 19/3431; G06F 19/345; G06F 19/325

(57) ABSTRACT

A medical triage assistance system helps to streamline remote medical triaging so that healthcare professionals can increase the number of patients they can assist, ensure high-quality care, and reduce operational costs. The medical triage assistance system receives an unstructured conversation between a patient and a healthcare professional that it organizes into call-response units that pair questions from the healthcare professional (or the medical triage assistance system) with their answers. The medical triage assistance system determines the patient's likely symptoms by traversing a knowledge graph that associates mundane language with medical symptoms based on tokens extracted from the call-response units. In some embodiments, the medical triage assistance system can also recommend and execute medical protocols based on the likely symptoms. The medical triage assistance system can generate the knowledge graph by applying machine learning techniques to patient complaint-symptom datasets that have both unstructured conversations and triage symptoms identified by healthcare professionals.

### BACKGROUND

This disclosure relates generally to medical triage, and in particular to a medical triage assistance system for messaging-based medical triage platforms.

Cost and convenience are two of the primary barriers to receiving quality healthcare. Medical triage is a crucial part of an efficient and effective healthcare system because it helps to ensure that patients get the correct level of care while reducing the amount of wasted resources. Through conversations with patients, triage nurses can determine patient symptoms and their severity, and direct patients to the appropriate next steps. Oftentimes, the appropriate next steps include at-home instructions that address the patient's symptoms, a remote interaction with a doctor (e.g., telemedicine), a home visit by a doctor, or a referral, which may avoid costly and unnecessary emergency room, urgent care or office visits. Many medical triage services are offered via convenient means, such as telephone hotlines and messaging platforms, allowing patients to receive proper medical advice from the comfort of their own home. However, because medical triage must be performed by properly trained healthcare professionals, scaling such systems can put strains on human capital and limit the extent of cost reductions typically seen with economies of scale.

### SUMMARY

A medical triage assistance system helps to streamline remote medical triaging so that healthcare professionals can increase the number of patients they can assist, ensure high-quality care, and reduce operational costs. The medical triage assistance system receives an unstructured conversation between a patient and a healthcare professional. In some embodiments, the medical triage assistance system is able to communicate directly with the patient such that a healthcare professional is only minimally involved. The medical triage assistance system is able to organize the unstructured conversation into call-response units that pair questions from the healthcare professional (or the medical triage assistance system) with their answers. The medical triage assistance system then can identify medically-relevant phrases from call-response units and tokenize those phrases so that it can use the tokens to determine likely symptoms of the patient. The medical triage assistance system traverses a knowledge graph based on the tokens to determine the likely symptoms. In some embodiments, the medical triage assistance system can also recommend and execute medical protocols based on the likely symptoms.

The medical triage assistance system may also be able to generate a knowledge graph that associates mundane language (i.e., from the unstructured conversations) with medical symptoms determined by healthcare professionals. Machine learning techniques may be used to train the knowledge graph based on patient complaint-symptom datasets that have both unstructured conversations and triage symptoms identified by healthcare professionals. The unstructured conversations in the patient complaint-symptom database are processed into tokens as described above, and may additionally be analyzed to determine which tokens are the most relevant to that particular unstructured conversation. Edges are then created between the tokens and the symptoms that were determined based on the unstructured conversation the tokens were extracted from.

### BRIEF DESCRIPTION OF THE DRAWINGS

FIG. 1 is a block diagram of a system environment in which a medical triage assistance system operates, according to one embodiment.

FIG. 2 is a block diagram of a medical triage assistance system, according to one embodiment.

FIG. 3 is a flow chart illustrating a method for determining patient symptoms and providing medical recommendations, according to one embodiment.

FIG. 4 illustrates an example conversation with its call-response units and medically relevant phrases indicated, according to one embodiment.

FIG. 5 is an example of the medical triage assistance system recommending a protocol based on a patient conversation, according to one embodiment.

FIG. 6 illustrates a training phase of the knowledge graph, according to one embodiment.

FIG. 7 illustrates an example knowledge graph, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

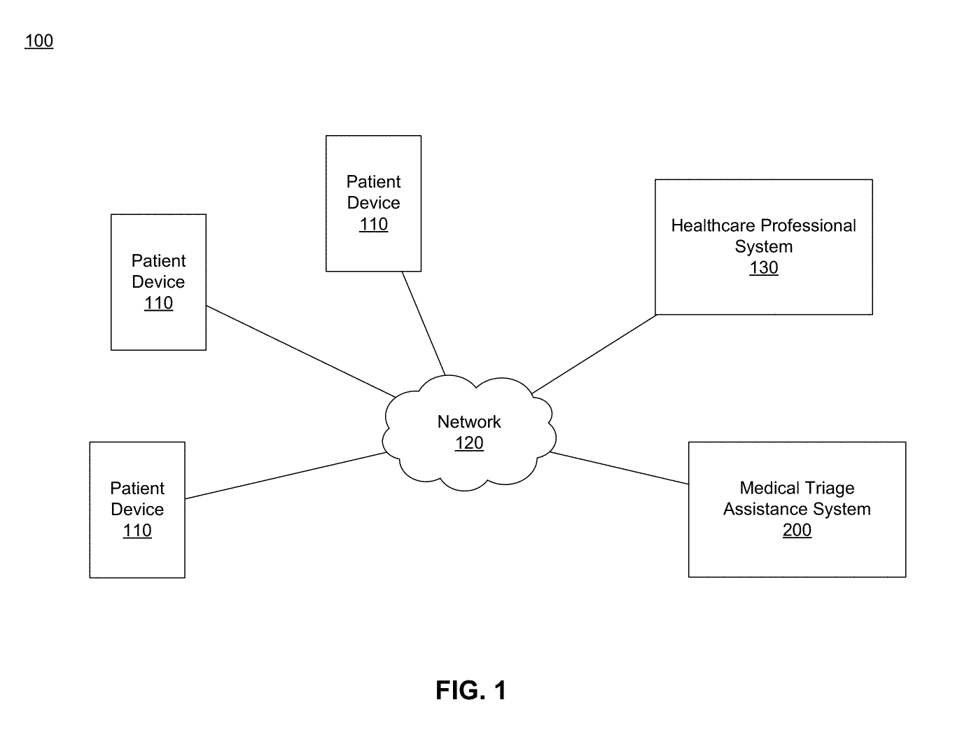

FIG. 1 is a block diagram of a system environment in which a medical triage assistance system 200 operates, according to one embodiment. Patients converse with medical professionals to discuss a patient's symptoms via the patient device 110 and healthcare professional system 130, respectively. The medical triage assistance system 200 aids messaging-based medical triage platforms by determining patient symptoms and providing medical recommendations based on patient conversations. The system environment 100 shown by FIG. 1 comprises one or more patient devices 110, a network 120, one or more healthcare professional systems 130, and the medical triage assistance system 200. In alternative configurations, different and/or additional components may be included in the system environment 100.

The patient devices 110 are one or more computing devices capable of receiving user input as well as transmitting and/or receiving data via the network 120. In one embodiment, a patient device 110 is a conventional computer system, such as a desktop or a laptop computer. Alternatively, a patient device 110 may be a device having computer functionality, such as a personal digital assistant (PDA), a mobile telephone, a smartphone, or another suitable device. A patient device 110 is configured to communicate via the network 120. In one embodiment, a patient device 110 executes an application allowing a user of the patient device 110 (i.e., a patient) to interact with the medical triage assistance system 200. For example, a patient device 110 executes a browser application to enable interaction between the patient device 110 and the medical triage assistance system 20 via the network 120. In another embodiment, a patient device 110 interacts the medical triage assistance system 200 through an application programming interface (API) running on a native operating system of the patient device 110, such as IOS®, ANDROID®, or WINDOWS®. In additional embodiments, a patient interacts with the triage assistance system 200 via a voice-controlled or voice-interaction system. For example, the patient may communicate with a healthcare professional by voice or audio conversation, which may be automatically transcribed and analyzed by the medical triage assistance system 200 as discussed here.

The patient devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML), extensible markup language (XML) or JAVASCRIPT® object notation (JSON). In some embodiments, all or some of the communication links of the network 120 may be encrypted using any suitable technique or techniques.

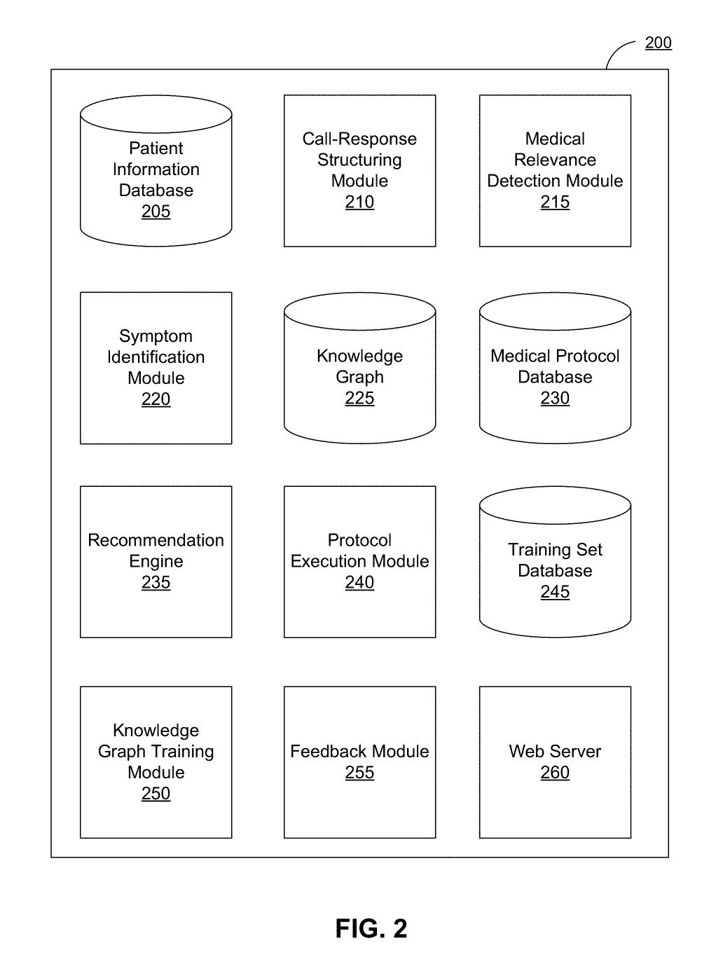

One or more healthcare professional systems 130 may be coupled to the network 120 for communicating with the medical triage assistance system 200, which is further described below in conjunction with FIG. 2. Each healthcare professional system 130 is operated by one or more healthcare professionals, which include nurses (e.g., registered nurses) and medical providers (e.g., doctors, nurse practitioners). A healthcare professional system 130 may additionally be associated with a medical group, such as a hospital or clinic.

In some embodiments, the medical triage assistance system 200 is not connected to both a patient device 110 and a healthcare professional system 130 directly. Instead, the medical triage assistance system 200 may be connected to the backend of a healthcare professional system 130 and receive information from the patient device 110 through the healthcare professional system 130. That is, the medical triage assistance system 200 may not receive direct input from the patient via the patient device 110. For example, conversations between the patient and the healthcare professional can take place through the healthcare professional system 130 and be sent to the medical triage assistance system 200 by the healthcare professional system 130.

FIG. 2 is a block diagram of a medical triage assistance system 200, according to one embodiment. The medical triage assistance system 200 includes modules and components for identifying relevant portions of a medical conversation, determining medical symptoms from the conversation, and recommending and executing medical protocols from the determined symptoms. The medical triage assistance system 200 shown in FIG. 2 includes a patient information database 205, a call-response structuring module 210, a medical relevance detection module 215, a symptom identification module 220, a knowledge graph 225, a medical protocol database 230, a recommendation engine 235, a protocol execution module 240, a training set database 245, a knowledge graph training module 250, a feedback module 255, and a web server 260. In other embodiments, medical triage assistance system 200 may include additional, fewer, or different components for various applications. For example, some embodiments of the medical triage assistance system 200 may include a natural language processing module to receive and process voice input. Conventional components such as network interfaces, security functions, load balancers, failover servers, management and network operations consoles, and the like are not shown so as to not obscure the details of the system architecture.

The patient information database 205 stores information about patients (i.e., users) of the medical triage assistance system 200. Patient information may include identification information, demographics, conversation records, symptoms, medical history, and health insurance claims data. Identification information may be an identifier within the medical triage assistance system 200 associated with the patient, or an identifier from a more ubiquitous entity, like a driver's license or social security number. Conversation records allow the medical triage assistance system 200 access to conversations between the patient and a healthcare professional or the medical triage assistance system 200. These conversations may take place via chat or text messages, or via audio or video calls. For chat or text messages, the conversation record contains the messages and an indication of who sent the message. For an audio or video call, the conversation record is a transcript and may also include who said what. Screenshots (from a video call) or images submitted by the patient may also be included in conversation records. For example, the patient may submit images of a rash. In some embodiments, a conversation between the patient and the healthcare professionals are routed through the medical triage assistance system 200. In this embodiment, the medical triage assistance system 200 is able to record the conversation while it is taking place. In other embodiments, the medical triage assistance system 200 may receive conversation records after the fact.

Symptoms are standardized medical concepts and terms defined by healthcare professionals that describe patient complaints. Symptoms may be explicitly specified by the patient, determined by a healthcare professional based on the patient's description, determined by a healthcare professional based on an in-person visit or determined by the medical triage assistance system 200 based on conversation records. Medical history information for the patient may be provided by one or more healthcare professionals and may include the patient's complete medical record, or a summary of relevant medical issues (such as allergies, chronic conditions and previous medical problems).

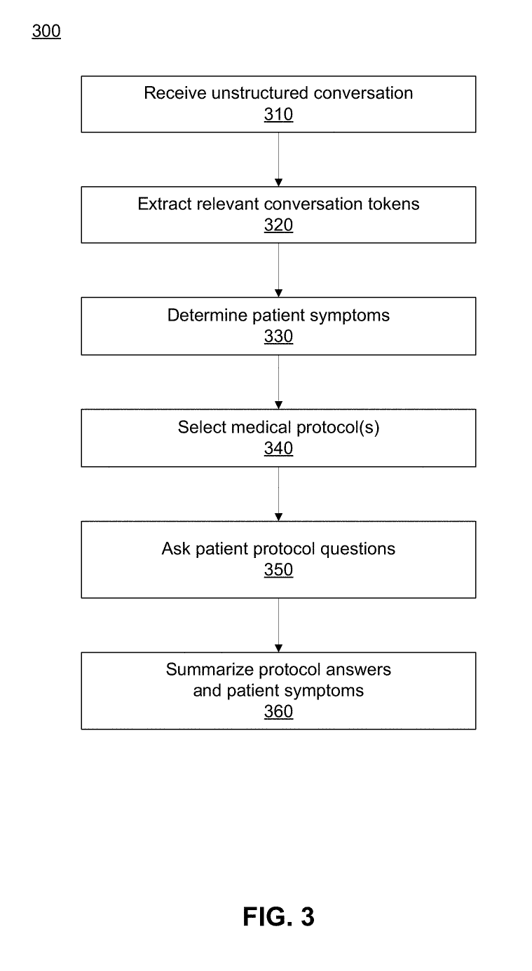

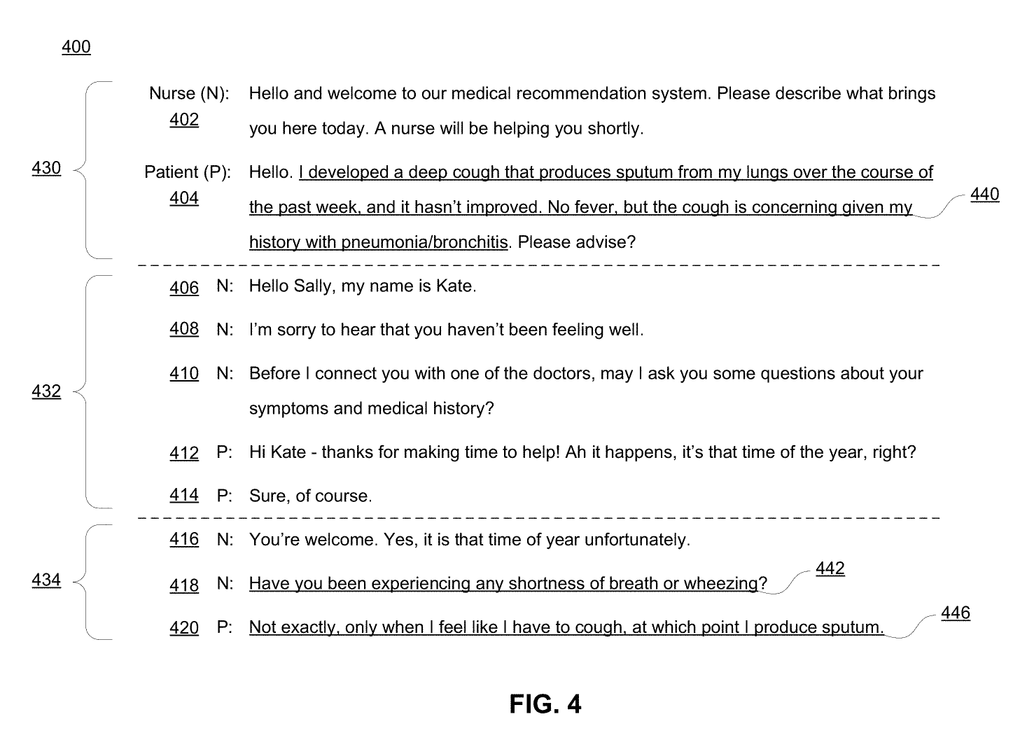

The call-response structuring module 210 organizes unstructured conversations (such as conversation records) into call-response units. Call-response units pair questions with corresponding answers to allow the medical triage assistance system 200 to better process the conversation content. For example, a patient's answer alone may omit relevant information that was posed in the preceding question. Call-response units are further described in conjunction with step 320 of FIG. 3 and with FIG. 4

The medical relevance detection module 215 identifies medically-relevant phrases by tokenizing call-response units (or in some cases, the unstructured conversation), and identifying medically-relevant tokens, such as “pain” and “cough.” The medically-relevant tokens are then mapped back to the call-response units, where they are expanded to medically-relevant phrases. In some embodiments, the medical relevance detection module 215 may modify the call-response units such only medically-relevant phrases are passed onto subsequent modules.

The symptom identification module 220 extracts medically-relevant conversation tokens from conversations and uses them to determine medical symptoms by traversing the knowledge graph 225. These tokens are made up of strings (or vectors) explicitly or implicitly derived from the conversation. The tokens may be identified with a type or class of token, such as patient complaints, duration of the complaint, and severity. Patient complaint tokens are words and phrases from mundane language (i.e., from conversations) that directly correspond to symptoms, while duration tokens indicate the duration of a complaint, and severity tokens indicate the severity of a complaint. Tokenization and traversal of the knowledge graph 225 are further discussed in conjunction with FIG. 3

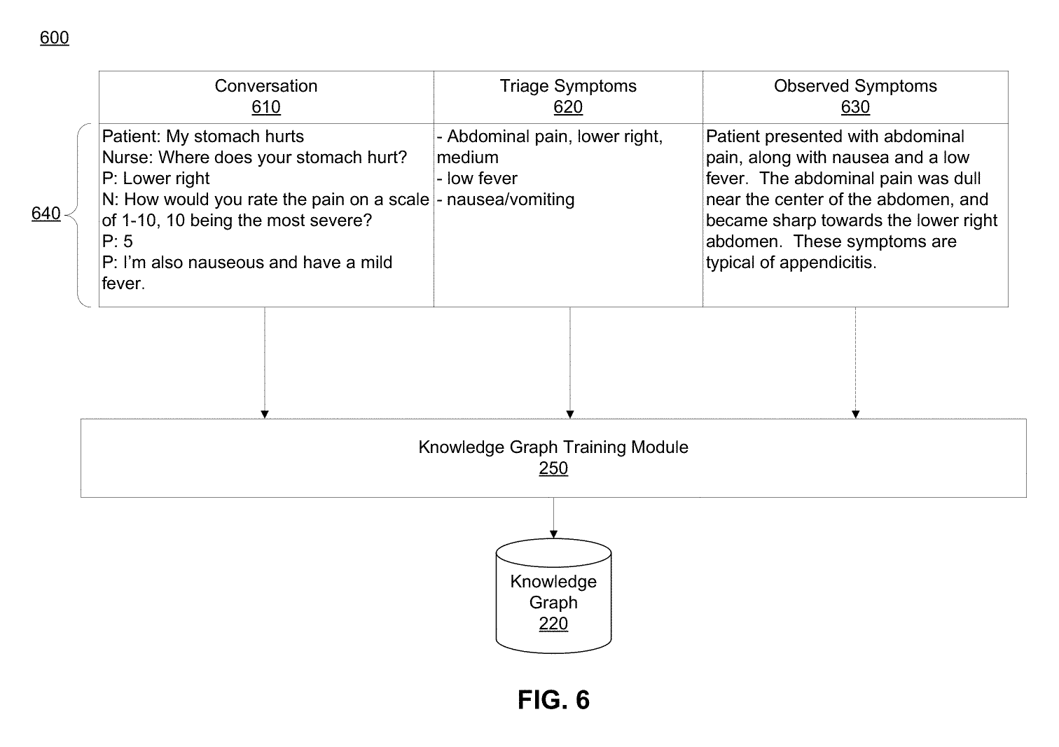

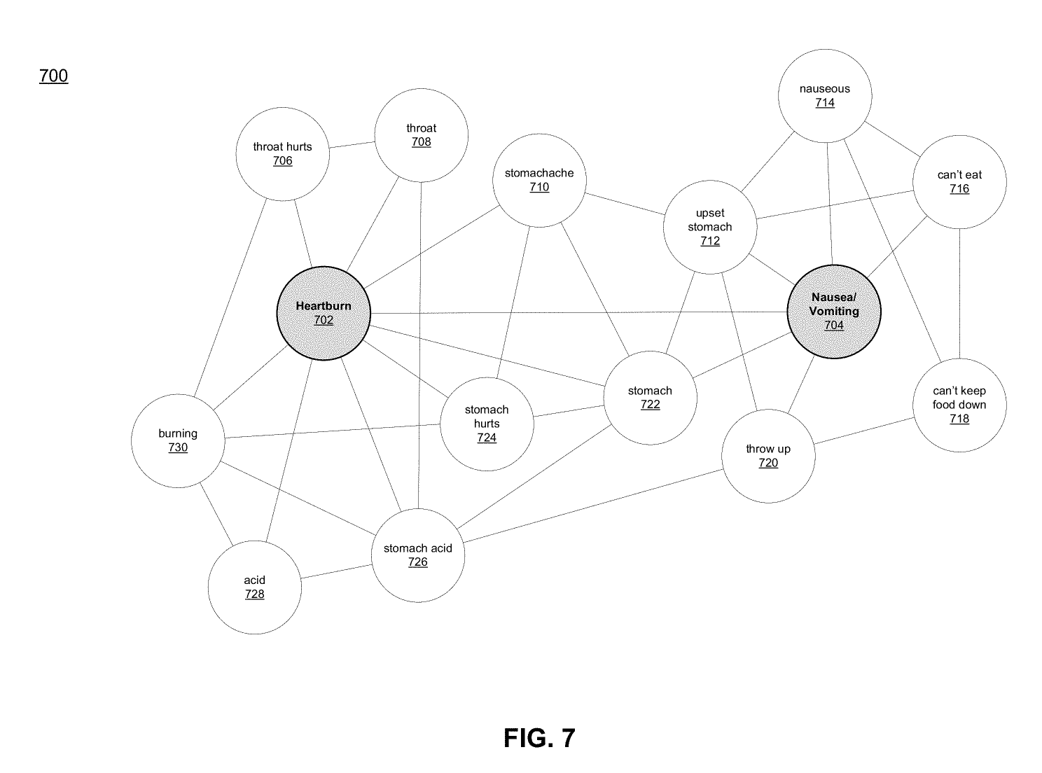

The knowledge graph 225 is a machine-learned model that associates the mundane language of patient complaints with medical symptoms and can be used to output probabilities of an input conversation being indicative of particular medical symptoms. In one embodiment, the knowledge graph 225 is also able to identify applicable medical protocols based on likely medical symptoms. A specific method for generating the knowledge graph is discussed in conjunction with the knowledge graph training module 250 and FIGS. 6-7.

The medical protocol database 230 stores medical protocols commonly used for triage. Medical protocols are a series of questions that help determine the urgency of a patient's complaints, as well as determine more information regarding their symptoms. In some embodiments, the medical protocol database 230 is external to the medical triage assistance system 200.

The recommendation engine 235 provides recommendations of medical protocols to apply to a particular patient based on their symptoms (or likely symptoms). The protocol execution module 240 then automates the execution of medical protocols from the medical protocol database 230. That is, the protocol execution module 240 asks the patient questions from a medical protocol according to a decision tree of the protocol. In some embodiments, the protocol execution module 240 also summarizes the patient's answers to the medical protocol.

The training set database 245 stores one or more patient complaint-symptom datasets that are used to generate the knowledge graph 225. These datasets are further described in conjunction with FIG. 6. In some embodiments, the training set database 245 is combined with the patient information database 205.

The knowledge graph training module 250 applies machine learning techniques to generate the knowledge graph 225. The knowledge graph training module 250 forms a positive training set of conversation tokens from patient conversations that are associated with the symptom in question and extracts feature values from the conversation of the training set, the features being variables deemed potentially relevant to whether or not the conversation is associated with the symptom. Different machine learning techniques—such as linear support vector machine (linear SVM), neural networks, logistic regression, naïve Bayes, memory-based learning, random forests, bagged trees, decision trees, boosted trees, or boosted stumps—may be used in different embodiments. Generating the knowledge graph 225 is further discussed in conjunction with FIGS. 6-7.

In some embodiments, a validation set is formed of additional conversations, other than those in the training set, which have already been determined to have or to lack the symptom in question. The knowledge graph training module 250 applies the trained validation knowledge graph 225 to the conversation tokens of the validation set to quantify the accuracy of the knowledge graph 225. Common metrics applied in accuracy measurement include: Precision=TP/(TP+FP) and Recall=TP/(TP+FN), where precision is how many the knowledge graph 225 correctly predicted (TP or true positives) out of the total it predicted (TP+FP or false positives), and recall is how many the knowledge graph 225 correctly predicted (TP) out of the total number of conversations that did have the property in question (TP+FN or false negatives). The F score (F-score=2*PR/(P+R)) unifies precision and recall into a single measure. In one embodiment, the knowledge graph training module 250 iteratively re-trains the knowledge graph 225 until the occurrence of a stopping condition, such as the accuracy measurement indication that the model is sufficiently accurate, or a number of training rounds having taken place.

The medical triage assistance system 200 receives feedback from healthcare professionals via the feedback module 255. The feedback module 255 utilizes the feedback in order to improve the knowledge graph 225. The feedback may take the form of a correction, for example, to the identified symptoms or recommended protocols. In some embodiments, healthcare professionals may also be able to provide positive feedback, such as a confirmation that a symptom is correct. The feedback module 255 may also solicit feedback using active learning techniques. For example, the medical triage assistance system 200 may ask a user whether a particular phrase can be mapped to a particular symptom.

The web server 260 links the medical triage assistance system 200 via the network 120 to the one or more patient devices 110, as well as to the one or more medical triage assistance systems 130. The web server 260 serves web pages as well as other content, such as JAVA®, Go, NODE.JS®, PYTHON®, JSON, HTML, XML, and so forth. The web server 260 may receive and route messages between the medical triage assistance system 200 and the patient device 110, for example, instant messages, queued messages (e.g., email), text messages, short message service (SMS) messages, or messages sent using any other suitable messaging technique. A patient may send a request to the web server 260 to upload information (e.g., images or videos) that are stored in the patient information database 205. Additionally, the web server 260 may provide application programming interface (API) functionality to send data directly to native client device operating systems, such as IOS®, ANDROID®, or WINDOWS®.

### Providing Medical Recommendations Based on Patient Conversations

FIG. 3 is a flow chart illustrating a method 300 for determining patient symptoms and providing medical recommendations based on patient conversations, according to one embodiment. The medical triage assistance system 200 receives 310 an unstructured conversation between the patient and a healthcare professional system 130 or the medical triage assistance system 200. An unstructured conversation is a record of a conversation that has not been processed for the medical triage assistance system 200. For example, an unstructured conversation may be a series of messages, a transcript of a conversation, or voice input. The unstructured conversation thus may not include metadata or other tags describing medical information related to the conversation.

The medical triage assistance system 200 extracts 320 relevant conversation tokens from the patient's unstructured conversation. The conversation tokens are words and phrases taken from the conversation. In some embodiments, the medical triage assistance system 200 avoids extracting 320 conversation tokens that are likely to not be medically-relevant by separating the conversation into “call-response” units, identifying medically-relevant phrases in the call-response units, and then tokenizing the medically-relevant phrases.

FIG. 4 illustrates an example conversation 400 with its call-response units 430, 432, 434 and medically relevant phrases 440, 442, 444 indicated, according to one embodiment. In this example, the conversation 400 corresponds to messages 402-420 between a healthcare professional (nurse) and a patient. The messages 402-420 are organized into three call-response units 430, 432, 434. Call response unit 430 corresponds to messages 402-404, call-response unit 432 corresponds to messages 406-414, and call-response unit 434 corresponds to messages 416-420. Three medically-relevant phrases 440, 442, 444 are underlined. Medically-relevant phrase 440 is in call-response unit 430, and medical-relevant phrases 442, 444 are in call-response unit 434.

Each call-response unit 430, 432, 434 includes a question (the call) from a healthcare professional or the medical triage assistance system 200 and one or more answers (the response) from the patient. This organization provides context for information provided by the patient while organizing the conversation into smaller units for more efficient processing. Specifically, organizing the conversation into call-response units 430, 432, 434 connects concepts that otherwise may be separated by speaker, such as answers to questions. For example, if a nurse asks “How bad is your tooth pain on a scale of 1 to 10?” and the patient replies “9,” grouping those two messages together allows the medical triage assistance system 200 to associate “9” with “tooth pain.”

In the example conversation 400, the boundaries for the call-response units 430, 432, 434 occur after a message sent by the patient when it is followed by a message from the nurse. That is, the boundaries that define the call-response units 430, 432, 434 occur between messages 404 (patient) and 406 (nurse), messages 414 (patient) and 416 (nurse). Alternatively, the medical triage assistance system 200 may identify the boundaries immediately before the nurse asks a question, which places the boundaries between messages 408 and 410, and messages 416 and 418. Using these boundaries, the call-response units 430, 432, 434 are identified as messages 402-408, messages 410-416, and messages 418-420, respectively.

Within each of the call-response units 430, 432, 434, the medical triage assistance system 200 identifies medically-relevant phrases 440, 442, 444. In one embodiment, this is done by tokenizing the call-response units 430, 432, 434 and analyzing the tokens to identify those that are medically-relevant. For example, the medical triage assistance system 200 may apply a neural network that has been trained to perform a logistic regression for medically-relevant terms or phrases. Medically-relevant tokens are then mapped back to the call-response units 430, 432, 434 and expanded into phrases. In one embodiment, any sentences containing medically-relevant tokens are identified as medically-relevant phrases. Looking at the call-response unit 430, the words “cough,” “sputum,” “fever,” “pneumonia,” and “bronchitis” are identified as medically-relevant tokens, so the sentences beginning with “I developed . . . ” and “No fever . . . ” are considered medically-relevant phrases. In this embodiment, the two sentences are merged into a single medically-relevant phrase 440 because they are adjacent and sent by the same user (the patient). In some embodiments, all medically relevant phrases 440, 442, 444 in a single call-response unit 430, 432, 434 (such as medically-relevant phrases 442 and 444) are merged.

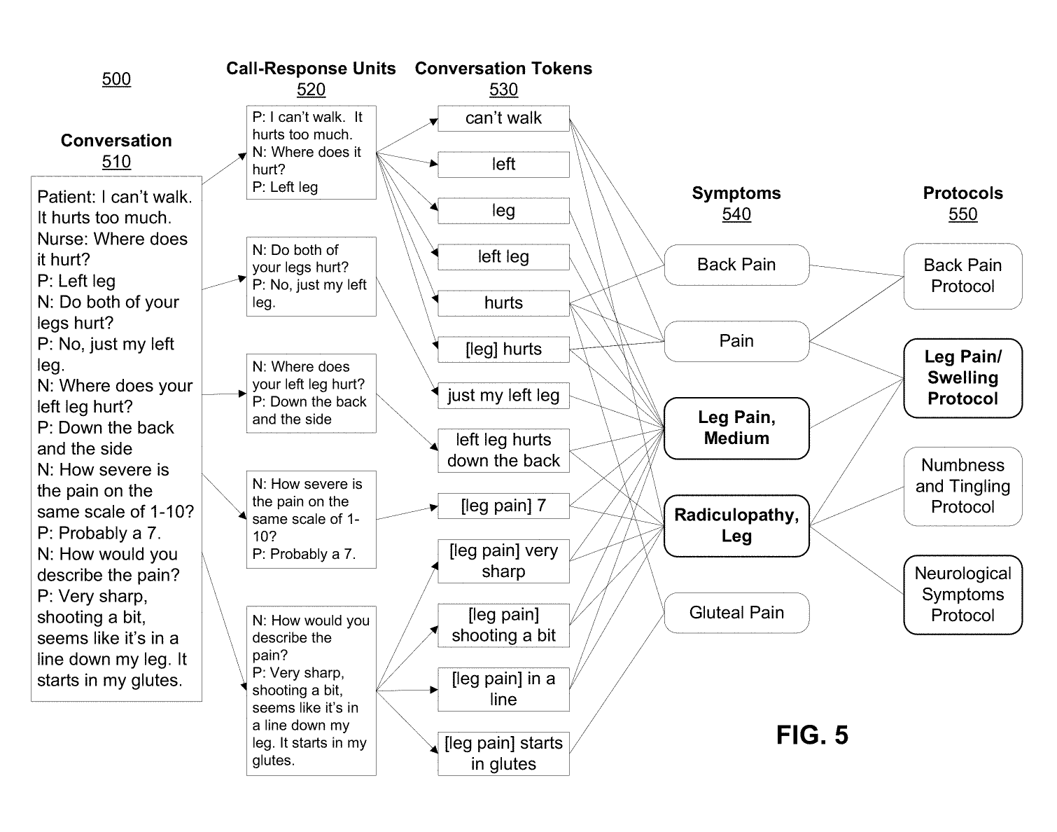

In some embodiments, only the medically-relevant phrases 440, 442, 444 are tokenized, while in other embodiments, the entire call-response unit is tokenized. Word-level tokens (unigrams) are extracted from the call-response units (or medically-relevant phrases of call-response units, in some embodiments) and normalized via stemming and lemmatization schemes. The normalization identifies and replaces tokens with their base word, which removes ambiguity that could be caused by different parts of speech and different tenses. For example, “coughing,” and “coughed” both become “cough.” In one embodiment, the medical triage assistance system 200 generates bi-grams (or other n-grams) from unigrams. The unigrams and bigrams (or n-grams) may be filtered to remove tokens that are repetitive or unlikely to be medically relevant (such as common words like “a,” “the,” “me,” etc.). In some embodiments, n-grams that have low medical relevance are also filtered out. The unigrams may also be filtered before any n-grams are generated to prevent the creation of n-grams containing words with low medical value. An example of call-response units being tokenized is shown and discussed in conjunction with FIG. 5.

Returning to FIG. 3, the medical triage assistance system 200 determines 330 the patient's symptoms based on the relevant conversation tokens. The medical triage assistance system 200 traverses the knowledge graph 225 based on the relevant conversation tokens and determines a probability and confidence level that the tokens are associated with specific symptoms. One method for generating the knowledge graph 225 is described in conjunction with FIGS. 7-8. Various complex network metrics, such as adjacency matrices and geodesic paths, may be used to traverse the knowledge graph 225. The knowledge graph 225 may also be traversed based on probabilistic modeling and detection of anchors and triplets, or deep Kalman filters, including deep learning and probabilistic modeling. Multiple symptoms can be presented to the nurse, along with the calculated probabilities and confidence levels.

In one embodiment, the medical triage assistance system 200 identifies nodes of the knowledge graph 225 that correspond to the conversation tokens and uses those nodes to determine associated symptoms, for example, by following edge weights of the knowledge graph 225. The tokens may be connected to a number of symptoms to different degrees, so in some embodiments the medical triage assistance system 200 may determine which symptoms are most relevant based on clustering and network metrics such as degree centrality, degree correlation or betweenness centrality. That is, symptoms that are clustered together in the knowledge graph 225 are more likely to represent correct symptoms to be associated with the conversation tokens. Some symptoms may be considered outliers if they are not part of or near the main clusters and may be discounted or ignored when selecting symptoms.

When the medical triage assistance system 200 receives conversations in real-time, it processes the received portions of the conversation as described above and updates its analysis with any newly received portions of the conversation. The medical triage assistance system 200 may then present preliminary symptoms to the nurse in real-time, which are updated as more portions of the conversation are received.

If the medical triage assistance system 200 receives a correction to the symptoms from the nurse, it can use that feedback to rebalance the connections of the knowledge graph 225 and re-score the multi-class classifier. A nurse can provide a correction by selecting the correct symptom that should have been identified, such as through a multiple-choice interface. The knowledge graph 225 is recomputed based on the correction and the recomputed knowledge graph 225 replaces the current knowledge graph 225 once a threshold improvement in performance is reached. Previous versions of the knowledge graph 225 may be stored to allow for analysis of historical data and models.

In some embodiments, presence of particular words and phrases are flagged as emergency situations that do not require the medical triage assistance system 200 to traverse the knowledge graph 225. Instead, the medical triage assistance system 200 may alert the nurse that the patient likely requires emergency care and should be immediately reviewed for confirmation. For example, if a patient reports that they have “profuse bleeding,” they likely need to go to the emergency room immediately, regardless of what symptoms their conversation indicates they're likely suffering from.

The medical triage assistance system 200 may also select 340 one or more specific medical protocols to recommend based on the patient's symptoms. Each medical protocol is based on one or more symptoms and is made up of a series of questions that are designed to differentiate between life-threatening conditions associated with that symptom and less urgent conditions. The medical triage assistance system 200 maps specific medical protocols to the various medical concepts of the knowledge graph 225. This mapping can be manually created, or learned (i.e., as part of the knowledge graph 225) based on existing patient cases. The medical triage assistance system 200 selects 340 the medical protocols based on confidence scoring. The medical triage assistance system 200 may present the selected 340 protocol(s) to the nurse as a recommendation and wait for approval or correction before proceeding. Manual corrections can be used to improve the mapping of medical protocols to medical concepts.

Once the protocol is selected 340 (and approved or corrected, if necessary), the medical triage assistance system 200 proceeds to ask 350 the patient protocol questions (following the decision tree of the protocol), automating the information collection generally performed by a nurse during triage. The protocols may include various questions requiring different types of answer entry, such as freeform, single-option, multiple-option or interactive graphic (e.g., sliders or image selection) entry. The medical triage assistance system 200 may summarize 360 the protocol answers and patient symptoms in order to allow the nurse to quickly review the relevant information needed to properly route the patient. In some embodiments, the medical triage assistance system 200 determines the severity of the patient symptoms and includes the severity in the summary. The severity may be determined based on the patient's protocol answers, or the conversation tokens.

FIG. 5 is an example 500 of the medical triage assistance system 200 recommending a protocol 550 based on a patient conversation 510, according to one embodiment. The medical triage assistance system 200 receives 310 the conversation 510 and identifies five call-response units 520. Thirteen conversation tokens 530 are extracted 320 from the call-response units 520. Some of the conversation tokens 530 are words that make up a phrase that is also a conversation token 530 (i.e., “left leg,” “left,” and “leg” are all conversation tokens 530). Some conversation tokens 530 also include inferred information, which is indicated in FIG. 5 as bracketed text. This information may be inferred based on the context of the conversation token 530. For example, for the token “[leg pain] 7,” “leg” is inferred from the conversation tokens 530 of call-response units 520 from earlier in the conversation 510, and “pain” is inferred from the nurse's question in that same call-response unit 520. In some embodiments, duplicate conversation tokens 530 are be omitted because they do not add additional information. Alternatively, duplicate conversation tokens 530 may be weighted more heavily than conversation tokens 530 that do not have duplicates to reflect their increased frequency relative to other conversation tokens 530.

In this example 500, the medical triage assistance system 200 connects conversation tokens 530 to related symptoms 540. Though the connections are shown as the same width in this example 500, they may actually be weighted based on the probability that the conversation token 530 is related to that particular symptom 540. The medical triage assistance system 200 determines 330 that the patient has the symptoms 540 that have the strongest connections to the conversation tokens 530, based on number of conversation tokens 530 being related to that symptom 540 and, in some embodiments, the weights of those connections. For this example 500, the symptoms 540 are determined 330 to be “Leg Pain, Medium” and “Radiculopathy, Leg.” These symptoms 540 map to various medical protocols 550. The medical triage assistance system 200 selects 340 the “Leg Pain/Swelling Protocol” based on the mapping of both determined 330 symptoms 540 to that protocol 550.

### Generating the Knowledge Graph

FIG. 6 illustrates a training phase 600 of the knowledge graph 225, according to one embodiment. The knowledge graph 225 is generated using a patient complaint-symptom dataset comprised of patient case summaries 640. Patients whose patient case summaries 640 are included in the dataset are those who had both a conversation 610 (e.g., chat-based) with a healthcare professional system 130 and an in-person visit with a medical provider. These patients are chosen because the medical provider is able to verify the patient's symptoms and provide treatment during the in-person visit.

Each patient case summary 640 in the patient complaint-symptom dataset includes a record of the patient's conversation 610 with the healthcare professional system 130, one or more triage symptoms 620, and one or more observed symptoms 630 from the in-person visit. The triage symptoms 620 and the observed symptoms 630 are both described in healthcare professional-defined medical language. In some embodiments, this medical language is standardized for better consistency across healthcare professionals. The triage symptoms 620 are determined by the healthcare professional (typically a nurse) operating the healthcare professional system 130 based on their conversation with the patient. The observed symptoms 630 are determined based on the observations of a medical provider who saw the patient during the in-person visit. The observed symptoms 630 are considered to be more accurate than the triage symptoms 620 because they are based on the medical provider's direct observation of the patient's symptoms, rather than the patient's description of them via a remote conversation 610.

In some embodiments, each patient case summary 640 is identified by an anonymized identifier that prevents a user of the patient complaint-symptom dataset from identifying the patient. However, the anonymized identifier may correspond to other medical information associated the patient outside of the patient complaint-symptom dataset, which may include identifying information. That is, the patient cannot be identified within the patient-complaint-symptom dataset but may be able to be identified based on other information not included in the dataset. The association of the anonymized identifier with other patient information outside of the dataset is useful because it allows other patient information (e.g., demographics) to be added to the dataset in the future without requiring that the entire dataset be recreated.

The knowledge graph 225 is generated using machine learning techniques. For each patient case summary 640, the conversation 610 is processed as described above in conjunction with FIG. 3—the conversation 610 is organized into call-response units, and medically-relevant phrases are tokenized into words and phrases. An information metric is applied to the tokens to determine which are the most likely to be medically relevant. For example, term frequency—inverse document frequency (tf-idf) can be applied to determine which tokens are present more frequently in the conversation relative to conversations from other patient case summaries in the dataset. The tokens and the triage symptoms from that conversation 610 are represented as vertices of the knowledge graph, and an edge is created between each token and each of the triage symptoms. Edges may also be created between tokens that are from the same conversation, allowing the knowledge graph 225 to record associations between words and phrases as well as words/phrases and symptoms. Additionally, some symptoms may be connected, for example, if they are commonly noted in the same set of triage symptoms.

In some embodiments, the accuracy of the triage symptoms 620 is evaluated before being associated with the tokens. Accuracy can be measured by comparing the triage symptoms to the observed symptoms 630. The more similar the triage symptoms 620 are to the observed symptoms 630, the higher likelihood that they are accurate. Triage symptoms 620 that are extremely different (e.g., below a certain threshold of similarity) may be excluded from the knowledge graph 225, or replaced by the corresponding observed symptoms 630. In some embodiments, the observed symptoms 630 may be used as vertices in the knowledge graph 225 in addition to or in lieu of the triage symptoms 620. The edges of the knowledge graph 225 may be weighted. This weighting can be based on how frequently of occurrence in the patient complaint-symptom dataset. The weighting can also factor in the accuracy of each of the edges (i.e., based on comparison of the triage symptoms 620 to the observed symptoms 630).

The knowledge graph 225 can also be generated based on other data in addition to patient cases. Data sets that have a mapping from mundane descriptions to precise medical terms or concepts, are related to medical symptoms, and are used in (call- or text-based) conversations can improve the connections of the knowledge graph 225. Such data sets may include modified Briggs triage protocols, medical conclusion report summaries, National Electronic Injury Surveillance System injury data, Substance Abuse and Mental Health Services Administration emergency department data, and Healthcare-Associated Infection data.

FIG. 7 illustrates an example knowledge graph 700, according to one embodiment. The vertices 702-730 of example knowledge graph 700 are symptoms 702-704 determined by healthcare professionals and word/phrases 706-730 from patient conversations (or other data sets). Example knowledge graph 700 is not comprehensive and thus does not include all possible vertices and edges.

Words/phrases 706-730 are connected to other words/phrases 706-730 from the same patient conversation, as well as the symptoms 702-704 that the nurse determined that the patient was suffering from based on the patient conversation. Patient A said that their “throat hurts and feels like it's burning,” which is split into “throat hurts” 706 and “burning” 730 and those two vertices are connected. Based on Patient A′s conversation, the nurse determined that Patient A was suffering from “Heartburn” 702, so “throat hurts” 706 and “burning” 730 are also connected to “Heartburn” 702. Phrases may also be connected to their component words. The phrase “throat hurts” 706 is connected to “throat” 708 for that reason. Similarly, “stomachache” 710, “upset stomach” 712, “stomach hurts” 724, and “stomach acid” 726 are all connected to “stomach” 722. In some embodiments, words that are too common or broad, like “hurts” and “pain” may not be included in the knowledge graph 700. Additionally, symptoms 702-704 that commonly experienced together may also be connected. For example, the Patient B was determined to have both “Heartburn” 702 and “Nausea/Vomiting” 704.

The edges of the knowledge graph 700 may be weighted based on the strength (based on frequency of co-occurrence) of the connection between the vertices 702-730. For example, “throw up” 720 is often colloquially used to mean “vomit” (i.e., “Nausea/Vomiting” 704) and “nauseous” 714 generally refers to “nausea” (i.e., “Nausea/Vomiting” 704), while “upset stomach” 712 can mean “Nausea/Vomiting” 704, but it can also refer to other types of stomach discomfort. Thus, “upset stomach” 712 refers to “Nausea/Vomiting” 704 less frequently than “throw up” 720 and “nauseous” 714 do. The connections between “throw up” 720 and “Nausea/Vomiting” 704, and “nauseous” 714 and “Nausea/Vomiting” 704 would be weighted more heavily than the connection between “upset stomach” 712 and “Nausea/Vomiting” 704 to reflect the difference in strength of connections.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving a plurality of patient case summaries, each patient case summary comprising an unstructured conversation between a patient and a healthcare professional and one or more triage symptoms determined by the healthcare professional;
for each of the plurality of patient case summaries:
extracting relevant conversation tokens from the unstructured conversation, each conversation token being a word or a phrase from the unstructured conversation;
identifying one or more symptoms associated with the unstructured conversation; and
creating an edge in the knowledge graph between each of the conversation tokens and the one or more symptoms; and
for each edge, weighting the edge based on the frequency of occurrence within the plurality of patient case summaries.

2. The method of claim 1, wherein the one or more symptoms are the one or more triage symptoms.

3. The method of claim 2, wherein the one or more triage symptoms have been compared to one or more observed symptoms determined by a medical provider during an office visit with the patient.

4. The method of claim 2, wherein each edge between a conversation token and a symptom is weighted based on an accuracy of the symptom.

5. The method of claim 1, wherein extracting relevant conversation tokens comprises:
organizing the unstructured conversation into one or more call-response units, each call-response unit including at least one question from the healthcare professional and at least one answer of the patient;
determining one or more medically-relevant phrases in the one or more call-response units; and
tokenizing the medically-relevant phrases to form the relevant conversation tokens.

6. The method of claim 5, wherein a call-response unit boundary is created before each question asked by the healthcare entity, the call-response unit boundary being used to determine an end of one call-response unit and a beginning of another call-response unit.

7. The method of claim 5, wherein the one or more medically-relevant phrases are determined using a neural network.

8. The method of claim 1, wherein extracting relevant conversation tokens further comprises:
applying term frequency-inverse document frequency to the conversation tokens relative to the plurality of patient case summaries to remove conversation tokens that are less likely to be relevant to the patient case summary.

9. A non-transitory computer-readable medium comprising instructions that when executed by a processor cause the processor to perform a method comprising:
receiving a plurality of patient case summaries, each patient case summary comprising an unstructured conversation between a patient and a healthcare professional and one or more triage symptoms determined by the healthcare professional;
for each of the plurality of patient case summaries:
extracting relevant conversation tokens from the unstructured conversation, each conversation token being a word or a phrase from the unstructured conversation;
identifying one or more symptoms associated with the unstructured conversation; and
creating an edge in the knowledge graph between each of the conversation tokens and the one or more symptoms; and
for each edge, weighting the edge based on the frequency of occurrence within the plurality of patient case summaries.

10. The non-transitory computer-readable medium of claim 9, wherein the one or more symptoms are the one or more triage symptoms.

11. The non-transitory computer-readable medium of claim 10, wherein the one or more triage symptoms have been compared to one or more observed symptoms determined by a medical provider during an office visit with the patient.

12. The non-transitory computer-readable medium of claim 10, wherein each edge between a conversation token and a symptom is weighted based on an accuracy of the symptom.

13. The non-transitory computer-readable medium of claim 9, wherein extracting relevant conversation tokens comprises:
organizing the unstructured conversation into one or more call-response units, each call-response unit including at least one question from the healthcare professional and at least one answer of the patient;
determining one or more medically-relevant phrases in the one or more call-response units; and
tokenizing the medically-relevant phrases to form the relevant conversation tokens.

14. The non-transitory computer-readable medium of claim 13, wherein a call-response unit boundary is created before each question asked by the healthcare entity, the call-response unit boundary being used to determine an end of one call-response unit and a beginning of another call-response unit.

15. The non-transitory computer-readable medium of claim 13, wherein the one or more medically-relevant phrases are determined using a neural network.

16. The non-transitory computer-readable medium of claim 9, wherein extracting relevant conversation tokens further comprises:
applying term frequency-inverse document frequency to the conversation tokens relative to the plurality of patient case summaries to remove conversation tokens that are less likely to be relevant to the patient case summary.
